(19) United States
(12) Patent Application Publication
(10) Pub. No.: US 2010/0253648 A1
(43) Pub. Date: Oct. 7, 2010

(54) TOUCH SENSOR WITH MODULAR SENSING COMPONENTS

(75) Inventor: Richard L. ST. PIERRE, North Andover, MA (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/752,696

(22) Filed: Apr. 1, 2010

Related U.S. Application Data
(60) Provisional application No. 61/167,027, filed on Apr. 6, 2009.

(51) Int. Cl. G06F 3/045; G06F 3/042; H04R 17/00

(52) U.S. Cl. 345/174; 345/176; 29/25.35

(57) ABSTRACT

A bending wave-type touch sensor for resolving contacts to a substrate, the touch sensor comprised of a plurality of sensor boards coupled to the substrate.

### CROSS REFERENCE TO RELATED APPLICATION

This application claims the benefit of U.S. Provisional Patent Application No. 61/167,027, filed Apr. 6, 2009, the disclosure of which is incorporated by reference herein in its entirety.

### BACKGROUND

A touch sensitive device offers a simple, intuitive interface to a computer or other data processing device. Rather than using a keyboard to type in data, a user can transfer information by touching an icon or by writing or drawing on a touch sensitive panel. Touch panels are used in a variety of information processing applications. Interactive visual displays often include some form of touch sensitive panel. Integrating touch sensitive panels with visual displays is becoming more common with the emergence of next generation portable multimedia devices such as cell phones, personal data assistants (PDAs), and handheld or laptop computers. It is now common to see electronic displays in a wide variety of applications, such as teller machines, gaming machines, automotive navigation systems, restaurant management systems, grocery store checkout lines, gas pumps, information kiosks, and hand-held data organizers, to name a few.

Various methods have been used to determine the location of a touch on a touch sensitive panel. Touch location may be determined, for example, using a number of force sensors coupled to the touch panel. The force sensors generate an electrical signal that changes in response to a touch. The relative magnitudes of the signals generated by the force sensors may be used to determine the touch location.

Capacitive touch location techniques involve sensing a current change due to capacitive coupling created by a touch on the touch panel. A small amount of voltage is applied to a touch panel at several locations, for example, at each of the touch screen corners. A touch on the touch screen couples in a capacitance that alters the current that flows from each corner. The capacitive touch system measures the currents and determines the touch location based on the relative magnitudes of the currents.

Resistive touch panels are typically multilayer devices having a flexible top layer and a rigid bottom layer separated by spacers. A conductive material or conductive array is disposed on the opposing surfaces of the top and bottom layers. A touch flexes the top layer causes contact between the opposing conductive surfaces. The system determines the touch location based on the change in the touch panel resistance caused by the contact.

Touch location determination may rely on optical or acoustic signals. Infrared techniques used in touch panels typically utilize a specialized bezel that emits beams of infrared light along the horizontal and vertical axes. Sensors detect a touch that breaks the infrared beams.

Surface Acoustic Wave (SAW) touch location processes uses high frequency waves propagating on the surface of a glass screen. Attenuation of the waves resulting from contact of a finger with the glass screen surface is used to detect touch location. SAW typically employs a “time-of-flight” technique, where the time for the disturbance to reach the pickup sensors is used to detect the touch location. Such an approach is possible when the medium behaves in a non-dispersive manner, such that the velocity of the waves does not vary significantly over the frequency range of interest.

Bending wave touch technology senses vibrations created by a touch in the bulk material of the touch sensitive substrate. These vibrations are denoted bending waves and may be detected using sensors typically placed on the edges of the substrate. Signals generated by the sensors are analyzed to determine the touch location.

### SUMMARY

In one embodiment, a contact sensitive device is described, comprising a first substrate capable of propagating bending wave vibration and having a touch surface; at least one sensor board coupled to the substrate, the sensor board including a second substrate onto which is mounted a sensor for measuring bending wave vibration of the first substrate; and a processor communicatively coupled to the at least one sensor board for processing information from the sensor related to a contact made on the touch surface.

In another embodiment, an apparatus is described, comprising: a circuit board having at least two conductive pads on a first circuit board surface, the two conductive pads each having a surface area; a sensor capable of sensing bending waves, the sensor having at least two conductive connection points on a first sensor surface, the first sensor surface having a surface area; wherein at least a portion of each of the at least two sensor pads are mechanically and electrically coupled to at least two areas of the first sensor surface that include the two conductive connection points; and wherein the surface area of the first sensor surface that is mechanically coupled to the two pads is greater than 20% of the total first sensor surface area.

In another embodiment, a method of making a touch sensitive device is described, comprising: mechanically coupling at least three sensor boards to a substrate, the sensor boards each including at least a piezoelectric sensor capable of measuring bending waves and providing signals indicative of measured bending waves; communicatively coupling the at least three sensor boards to electronics, the electronics configured to receive signals from the piezoelectric sensor and based on these signals provide signals indicative of the coordinates of a contact made to the substrate.

### BRIEF DESCRIPTION OF DRAWINGS

FIG. 1 is a drawing of the corner of touch sensor.

FIG. 2 is a drawing of a sensor board.

FIG. 3 is a drawing of a touch sensor and controller.

FIG. 4 is a drawing of a circuit board substrate of a sensor board.

FIG. 5 is a schematic illustrating the placement of a transducer onto a circuit board substrate.

FIG. 6 is a graph illustrating the frequency response of various sensor board configurations.

FIG. 7 is a graph illustrating the frequency response of a sensor board configuration and a standard sensor.

### DETAILED DESCRIPTION

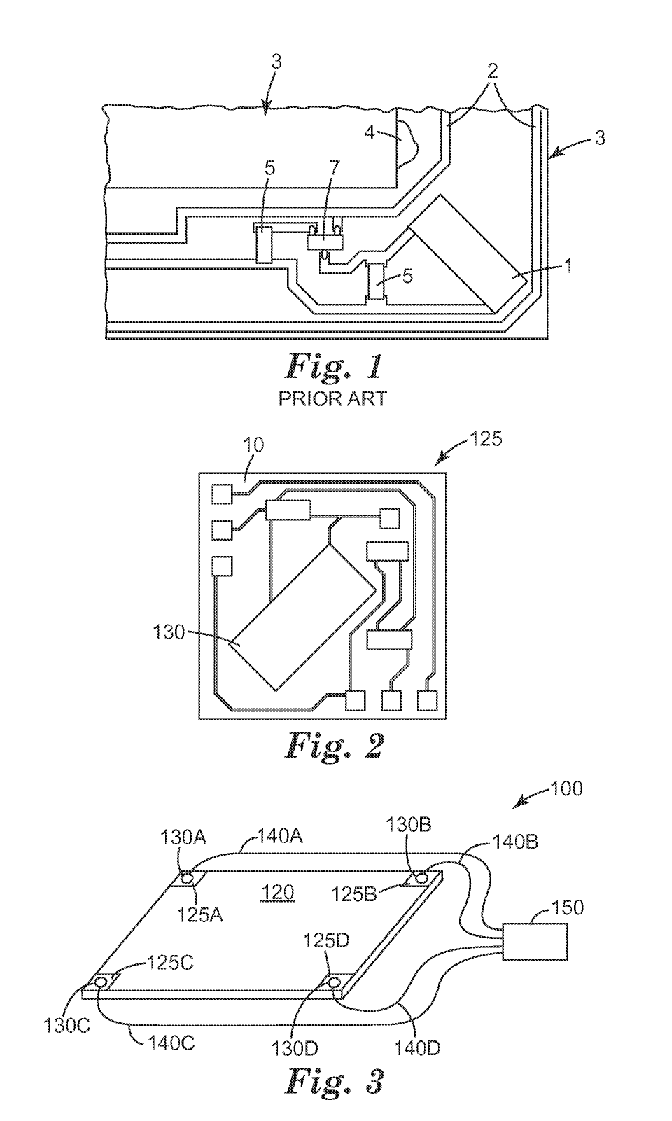

FIG. 1 is a drawing of the corner of a bending wave-type touch screen, such as that sold under the trade name MicroTouch DST by 3M Touch Systems, Methuen, Mass. Glass 3 has upon it conductive traces 2, which are electrically coupled to electrical components (two resistors 5 and a field effect transistor 7), which are in turn coupled via the conductive traces to piezoelectric sensor 1. These conductive traces and electrical components embody a voltage buffer circuit that connects high impedance input from the piezoelectric sensor into a low impedance output that goes to the controller (thus reducing noise interference and signal loss). This design has certain limitations. For example, it is necessary to print conductive traces onto the glass, which necessitates printing and baking equipment tailored to the glass sizes, which in turn makes scaling to new sizes difficult. Further, effectively securing the piezoelectric sensor directly on the glass requires a special process, as does placing the electrical components. Also, the conductive traces 2 may “bleed” in certain environmental conditions, potentially compromising the circuits formed by the conductive traces. Also, the conductive traces are susceptible to electrical noise from other components from, for example, a display device that would likely be in proximity to the touch screen. The noise issue is dealt with in the touch sensor shown in FIG. 1 using shielding tape 4, which is applied on the glass side opposite the conductive traces, but the application of the tape is yet another process step and material cost. Combined, these aspects of the design shown in FIG. 1 lend themselves to a number of process steps that involve the handling and manipulation of large sheets of glass.

The present invention relates to an apparatus that may, in some embodiments, address certain of these limitations, or provide new benefits not relating to these limitations. Further, this invention relates to an apparatus that may enable new devices or applications that are not tied to any of the aforementioned limitations. Further, this invention relates to new methods of making a touch sensitive device.

In the following description of the illustrated embodiments, reference is made to the accompanying drawings that form a part hereof, and in which is shown by way of illustration, various embodiments in which the invention may be practiced. It is to be understood that the embodiments may be utilized and structural changes may be made without departing from the scope of the present invention.

A touch sensing apparatus implemented in accordance with the present invention may incorporate one or more of the features, structures, methods, or combinations thereof described herein. It is intended that such a device, or method as the case may be, need not include all of the features and functions described herein, but may be implemented to include selected features and functions that, in combination, provide for useful structures and/or functionality.

The present invention relates to touch activated, user interactive devices and methods that provide for sensing of vibrations that propagate through a substrate for sensing by a number of transducers. More particularly, the present invention relates to touch sensing devices and methods that employ transducers configured to sense bending wave vibrations that propagate through a substrate, from which touch location information may be determined using disparate touch location detection techniques. Such touch sensing devices, associated algorithms, and techniques used to resolve data from the transducers into a touch location on the substrate are described in U.S. Pat. Nos. 7,157,649 “Contact Sensitive Device” (Hill); 6,871,149 “Contact Sensitive Device” (Sullivan et. al.); 6,922,642 “Contact Sensitive Device” (Sullivan); 7,184,898 “Contact Sensitive Device” (Sullivan et. al.); and in US Pat. application publication no. 2006/0244732, “Touch Location Determination using Bending Mode Sensors and Multiple Detection Techniques” (Geaghan), the contents of each of which is hereby incorporated by reference in its entirety.

The term bending wave vibration refers to an excitation, for example by a physical contact, which imparts some out of plane displacement to a member capable to supporting bending wave vibrations. Many materials bend, some with pure bending with a perfect square root dispersion relation and some with a mixture of pure and shear bending. The dispersion relation describes the dependence of the in-plane velocity of the waves on the frequency of the waves. The term bending may also apply to out of plane displacement or deflection of a member when subject to loading, such as when a touch panel deflects (for example, is subject to bowing) in response to a touch applied to the surface of the touch panel. In this regard, one surface of the touch panel is placed in compression, while the opposing surface is placed in tension, which results in bowing of the touch panel. Such bowing of the touch panel may be detected using bending mode sensors of a type described herein and in a manner discussed below.

In vibration sensing touch input devices that include piezoelectric sensors, for example, vibrations propagating in the plane of the touch panel plate stress the piezoelectric sensors, causing a detectable voltage across the sensor. The signal received can be caused by a vibration resulting directly from the impact of a direct touch input or the input of energy due to a trace (friction), or by a touch input influencing an existing vibration, for example by attenuation of the vibration. The signal received can also be caused by an unintended input, such as an input resulting from user handling or mishandling of the touch input device, or from environmental sources external to, but sensed by, the touch input device.

Turning to FIG. 2, a drawing of a sensor board 125 is shown. The term “sensor board” refers to a component including a substrate suitable for mounting electronics (for example, a circuit board), a sensor capable of detecting bending waves and associated electronics as needed to provide electronic signals indicative of the bending waves. For example, in one embodiment as provided in FIG. 2, the sensor board includes circuit board 10 onto which is mounted sensor 130 (in this case a piezoelectric sensor that produces a voltage when deformed, for example, by bending waves propagating through the substrate due to a contact event). The sensor board illustrated in FIG. 2 also includes a field effect transistor (FET), two resistors, and connection points for wires leading to electronics (not shown in FIG. 2) that receive signals from the sensor board and process those signals into, in some embodiments, the two dimensional coordinates of a touch event on the substrate. In other embodiments, the “associated electronics” may be eliminated as necessary, given the operating conditions of the anticipated end application.

Sensors 130 are preferably piezoelectric sensors that can sense vibrations indicative of a contact input to substrate, as will be more fully described below. Useful piezoelectric sensors include unimorph and bimorph piezoelectric sensors. Piezoelectric sensors offer a number of advantageous features, including, for example, good sensitivity, relative low cost, adequate robustness, potentially small form factor, adequate stability, and linearity of response. Other sensors that can be used in vibration sensing touch sensitive devices include electrostrictive, magnetostrictive, piezoresistive, acoustic, capacitive, and moving coil transducers/devices, among others.

Turning now to FIG. 3, there is illustrated one configuration of a touch sensitive device 100 that incorporates features and functionality for detecting bending wave vibrations and determining touch location using a multiplicity of disparate touch location detection techniques. According to this embodiment, the touch sensitive device 100 includes a substrate 120 and sensing boards 125 (which include vibration sensors 130) which are in turn coupled to an upper surface of the substrate 120. In this illustrative example, the upper surface of the substrate 120 defines a touch sensitive surface. Although sensors 130 are shown coupled to the upper surface of the substrate 120, the sensor boards 125 can alternatively be coupled to the lower surface of the substrate 120. In another embodiment, one or more sensor boards 125 may be coupled to the upper surface while one or more other sensor boards 125 may be coupled to the lower surface of the touch substrate 120. The sensor boards 125A-125D can be coupled to touch plate 120 by any suitable means, for example using an adhesive or other suitable material, so long as the mechanical coupling achieved is sufficient for vibrations propagating in the touch plate to be detected by the vibration sensors. Further discussion on mounting sensor boards to the substrate is provided below. Exemplary vibration sensors 130 and vibration sensor arrangements are disclosed in co-assigned U.S. patent application Ser. No. 10/440,650 (Robrecht) and U.S. Ser. No. 10/739,471 (Hill), which are fully incorporated herein by reference into this document.

Substrate 120 may be any substrate that supports vibrations of interest, such as bending wave vibrations. Exemplary substrates 120 include plastics such as acrylics or polycarbonates, glass, steel, aluminum, or other suitable materials. In general, any material whose dispersion relation is known could be used. Touch substrate 120 can be transparent or opaque, and can optionally include or incorporate other layers or support additional functionalities. For example, substrate 120 can provide scratch resistance, smudge resistance, glare reduction, anti-reflection properties, light control for directionality or privacy, filtering, polarization, optical compensation, frictional texturing, coloration, graphical images, and the like. In one embodiment, substrate 120 is a rectangular piece of glass. In another embodiment, substrate 120 is a sheet-type substrate in that it is thin relative to its length and width. In some embodiments, substrate 120 is of relatively uniform thickness. Pat. App. No. 61/080,966 “Systems and Methods for Correction of Variations in Speed of Signal Propagation Through a Touch Contact Surface” describes methods and algorithms for compensating for variances in the uniformity of the substrate, and is fully incorporated herein by reference into this document. Substrate 120 may be very large, in sizes well exceeding 46″ in the diagonal. For example, substrate 120 may be 50″, 60″, 70″, 80″, 90″ or even 100″ in the diagonal. Even larger sizes are conceivable, limited only by the size where vibrations become too small to be detected by the sensors.

Substrate 120 may be already incorporated into some other application not necessarily intended for use as a touch-sensitive device. For example, the sensor boards could be affixed to the glass on a window.

In some embodiments, substrate 120 includes conductive traces running near its edges to reduce the profile of electrical connectors 140. In general, the touch sensitive device 100 includes at least three sensor boards 125 to determine the position of a touch input in two dimensions, and four sensor boards 125 (shown as sensor boards 125A, 125B, 125C, and 125D in FIG. 3) may be desirable in some embodiments, as discussed in U.S. Pat. Nos. 6,922,642 (Sullivan) and 7,157,649 (Hill) and in co-assigned U.S. patent application Ser. No. 09/746,405, each of which are fully incorporated herein by reference into this document. In some embodiments where precise coordinates of a touch event are not needed, less sensors boards 125 may be used. For example, one sensor board 125 may be used in applications where two dimensional resolution requirements are less restrictive. For example, in a display device for example in advertising, a touch sensitive device 100 may be used in conjunction with a display (such as an LCD display) which displays instructions to would-be users advising them to “Touch Screen to Begin.” In such an embodiment, the two dimensional coordinates of the touch location would not be necessary. Also, embodiments deploying only two sensor boards 125 may provide somewhat more resolution in determining whether particular areas of the screen have been touched. For example, in the above advertising example, the touch sensitive device coupled with a display may instead solicit input from would-be users with a message in two discreet areas of the screen: “Touch Here to Begin in English” and “Touch Here to Begin in Spanish.” In such case, depending on the placement of the discreet areas on the screen, it may not be necessary to include four sensor boards to meet the touch resolution requirements. In this particular example, two sensor boards could provide adequate resolution.

In one embodiment, all of the sensors 130 are configured to sense vibrations in the touch substrate 120. The sensors 130 may be substantially the same in terms of technology and functionality. For example, all of the sensors 130 may be bending mode sensors produced by a particular manufacturer under the same part number or identification. In other embodiments, the sensors 130 may be substantially the same in terms of technology, but differ in terms of functionality. For example, all of the sensors 130 may be bending mode sensors produced by a particular manufacturer, with some of these sensors implemented to detect bending waves and other sensors implemented to detect plate deflection. In some embodiments, one or more of the sensors 130 may be a sensor other than a bending mode sensor.

In accordance with another embodiment, one or more of the sensors 130 can be used as an emitter device to emit a signal that can be sensed by the other sensors 130 to be used as a reference signal or to create vibrations that can be altered under a touch input, such altered vibrations being sensed by the sensors 130 to determine the position of the touch. An electrodynamic transducer may be used as a suitable emitter device. Moreover, one or more of the sensors 130 can be configured as a dual purpose sense and excitation transducer, for example as disclosed in previously incorporated U.S. Pat. Nos. 6,922,642 and 7,157,649, as well as in co-assigned U.S. Pat. No. 7,411,584 (Hill), which is fully incorporated herein by reference into this document.

Many applications that employ touch sensitive devices 100 also use electronic displays to display information through the touch sensitive devices 100. Such displays include, for example, liquid crystal displays, plasma displays, and organic light emitting diode displays. Since displays are typically rectangular, it is typical and convenient to use rectangular touch sensitive devices 100. As such, the touch substrate 120 to which the sensors 130 are affixed is typically rectangular in shape, it being understood that other geometries may be desirable.

According to one configuration, the sensor boards 125A, 125B, 125C, 125D are preferably placed near the corners of the substrate 120. Because many applications call for a display to be viewed through the touch sensitive devices 100, it is desirable to place the sensor boards 125A-D near the edges of the touch substrate 120 so that they do not undesirably encroach on the viewable display area. Placement of the sensors 125A-D at the corners of a touch substrate 120 can also reduce the influence of acoustic reflections from the substrate edges.

The contact sensed by the touch sensitive device 100 may be in the form of a touch from a stylus, which may be in the form of a hand-held pen. The movement of a stylus on the touch substrate 120 may generate a continuous signal, which is affected by the location, pressure and speed of the stylus on the touch substrate 120. The stylus may have a flexible tip, for example of rubber, which generates bending waves in substrate 120 by applying a variable force thereto. The variable force may be provided by the tip, which alternatively adheres to or slips across a surface of the substrate 120. Alternatively, the contact may be in the form of a touch from a finger that may generate bending waves in the touch substrate 120, which may be detected by passive and/or active sensing. The bending waves may have frequency components in the ultrasonic region (>20 kHz).

The touch sensitive device 100 shown in FIG. 3 is communicatively coupled to a controller 150. The sensor boards 125A-D are communicatively coupled to the controller 150 via conductors (for example, wires) or a printed electrode pattern developed on the touch substrate 120. The controller 150 typically includes front end electronics that measure signals or signal changes from the sensors on the sensor boards 125A-D. In another embodiment, controller 150 applies signals to the sensors on the sensor boards 125-A-D. In other configurations, the controller 150 may further include a microprocessor in addition to front end electronics. The controller 150, as is described in detail below, is capable of implementing one or more touch location detection techniques selected from a library of disparate touch location detection techniques, as is described, for example, in patent application publication no. 2006/0244732, “Touch Location Determination using Bending Mode Sensors and Multiple Detection Techniques” (Geaghan), which was earlier incorporated by reference into this document.

In a typical deployment configuration, the touch sensitive device 100 is used in combination with a display of a host computing system (not shown) to provide for visual and tactile interaction between a user and the host computing system. The host computing system may include a communications interface, such as a network interface, to facilitate communications between a touch panel system that incorporates touch sensitive device 100 and a remote system. Various touch panel system diagnostics, calibration, and maintenance routines, for example, may be implemented by cooperative communication between the touch panel system and the remote system.

Using sensor boards in configurations described herein may provide certain benefits. For example, a display manufacturer interested in producing touch-sensitive displays could purchase a kit containing sensor boards 125 and associated electronics, or just the sensor boards 125 if the electronics are already incorporated into the electronics for the touch-sensitive display. The display manufacturer is then afforded a great deal of flexibility in determining the particulars of how the assembly process could be most efficiently adapted to accommodate the step of affixing the sensor boards.

### Calibration

Given the distance from a tap point to each of the sensor boards, as well as the thickness, density, and Young's modulus of the substrate, a relatively straightforward calibration process may be used to fine-tune resolution of touch points. For example, the substrate may be tapped at a known location, then the signals measured by the sensor bards, yielding data. Using this data, along with the locations of the sensor boards and the physical properties of the substrate, an accurate model of the substrate can be determined and used to calculate touches in unknown locations. Additional points may be tapped to further refine calibration.

### Sensing Considerations

The piezoelectric sensor (sensor 130 in FIG. 2 and FIG. 3) is designed to measure bending waves in substrate 120. These bending waves are generally high frequency (5-20 kHz). Therefore the interfaces and layers between sensor 130 and substrate 120 must not unacceptably attenuate these vibrations. In the sensor board embodiment as described in FIG. 2, there exist three interfaces between sensor 130 and substrate 120. These include 1) sensor 130 to circuit board 10 interface; 2) circuit board 10 itself; and 3) the circuit board 10 to substrate 120 interface. These will be discussed in the following subsections.

### 1) Sensor to Circuit Board Interface

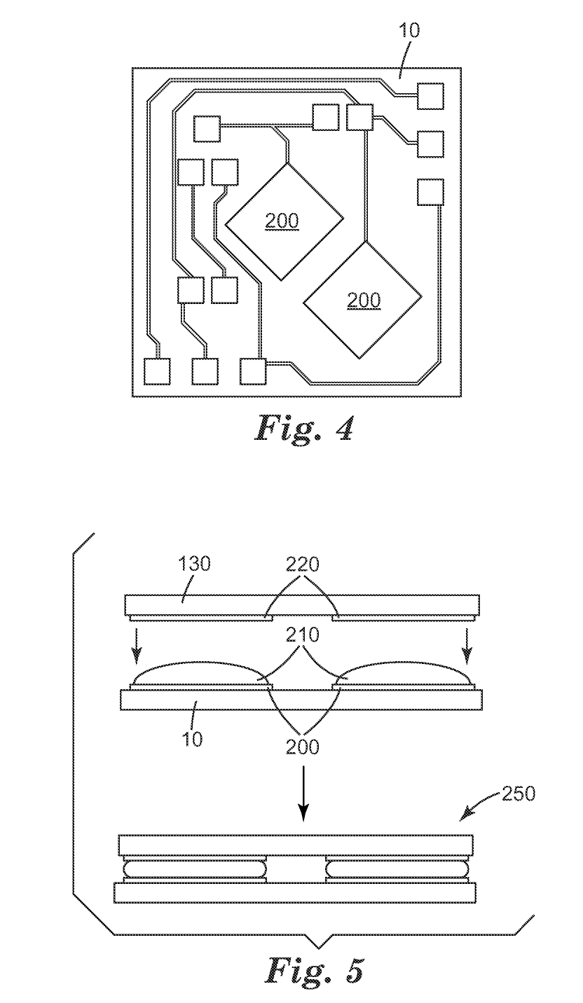

The mounting of the piezoelectric sensor to the circuit board is an important factor in achieving good measurement of bending waves in the substrate. The mechanical bond between the circuit board and piezoelectric sensor must be strong enough to fully couple the substrate 120 vibrations to the sensor 130. Initial attempts using sensor boards used a thin pad to bond the sensor 130 only along the edge using solder. This did not result in a strong enough bond. A second circuit board layout design, shown in FIG. 4, uses much larger pads 200 to secure sensor 130. These larger pads 200 allow contact with the sensor 130 pads over a large surface area, resulting in a strong bond.

It was found that the suitable technique to solder the sensor the circuit board shown in FIG. 4 is to heat pads 200 and flow a bead of solder on them, then place the sensor 130 onto the solder without pushing it down onto the pad. This leaves a layer of solder between sensor 130 and pads 200. As the solder cools, it will pull sensor 130 to a tight bond. When being done by hand, it is difficult to carry out the operation on both pads at once. In such case, one pad is done using this method, then the second pad is soldered by heating the pad and allowing solder to flow under the sensor. A diagram of this soldering procedure is shown in FIG. 5, which shows sensor 130, with its two pads 220, being mated with circuit board 10's pads 200, which have on them respective beads of heated solder 210, so as to produce the sensor/circuit board interface 250.

Adequate test results were achieved when about 50% of total surface area of the side of the sensor having pads 220 was mechanically coupled (via solder) to the pads 200. It is expected that adequate results could be similarly achieved with as low as about 20% of the total surface area of the side of the sensor having pads 220 being mechanically coupled to the sensor pads.

### 2) Circuit Board

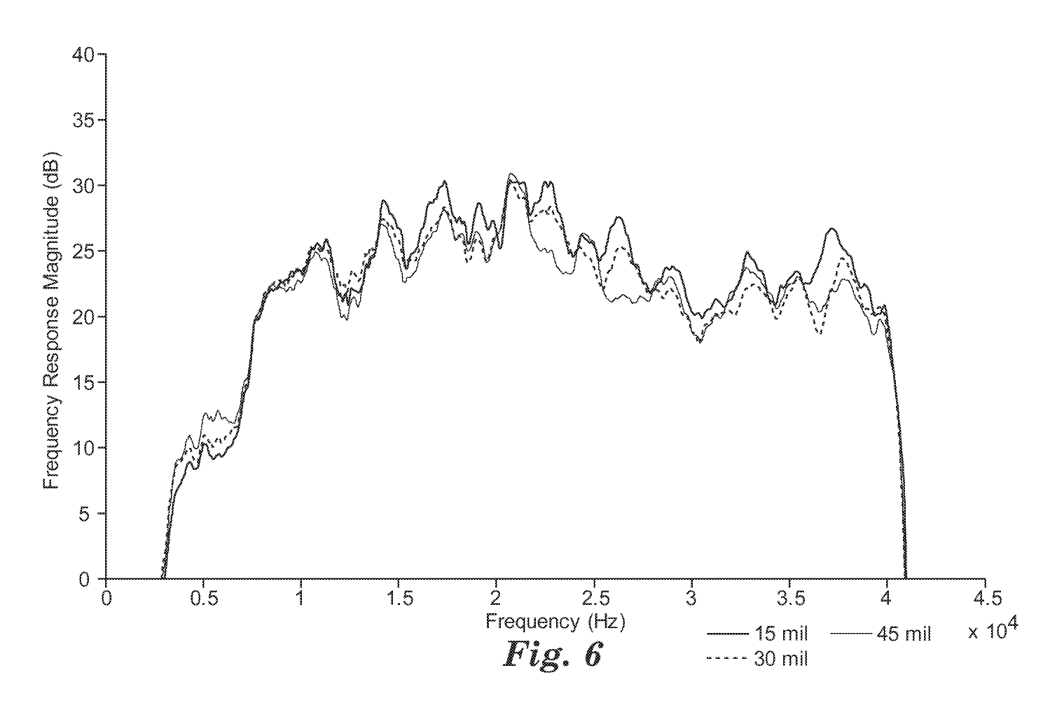

The circuit board itself is an interface between the sensor 130 and substrate 120. Typical FR-4 (a type of flame retardant material commonly used for circuit boards) circuit board material did not have a substantial adverse effect on the transmitted vibrations. However a test was done to see if the thickness of the circuit board had an effect on the sensing. The results of this test are summarized in FIG. 6, and more fully discussed later. Generally, the thickness of the circuit board had insignificant impact on the sensor response. In practice, it is desired in some embodiments that the circuit board be as thin as possible to minimize the gap needed between the sensor and the display. Circuit boards of 30 mil and 15 mil thicknesses have adequate clearances for some applications.

### 3) Circuit Board to Substrate Interface

Initial testing of sensor boards for this interface used an adhesive sold under the name of “Loctite Superglue” (marketed by a division of Henkel Corporation of Düsseldorf, Germany). Performance was adequate.

Because of the desire to avoid heat curing (which require ovens and associated handling/process steps), we tried several commercially available UV-cured adhesives from 3M Company of St. Paul, Minn. LC-1112 and LC-1212 are light cured adhesives that produce rigid bonds. Both were found to provide excellent transmittance of vibration to the sensor. Light cured adhesives may be particularly suited to mounting sensor boards to a glass substrate, because such a substrate is typically transparent, thus allowing the use of handheld light sources.

It is important that the bond between the circuit board and the substrate does not become flexible under the typical heating seen during use in some applications (for example, when mounted to a display). Temperatures in such applications can reach, for example, 40 to 50 degrees C. between the touch panel and the display surface. Under normal typical LCD-type display heating conditions, no adverse effects on performance were seen using the LC-1212 adhesive.

In one embodiment, the sensor board is designed so sensor 130 is properly aligned on the substrate if the sensor board is bonded using the glass edges as a guide. In this way, the proper positioning of the sensor can be controlled.

### Wiring Considerations

Sensor boards need to be communicatively coupled to the controller 150. In one embodiment, this is accomplished by means of a thin wiring harness composed of conductors or a flex circuit that is adhered to the substrate. In one test, we successfully used 34 AWG magnet wire to connect the sensor boards to a controller.

In some embodiments, a potential advantage of using sensor boards is the ability to minimize noise contamination from a nearby display, other electronics, or external sources. For example, both LCD and plasma displays generate a significant amount of high frequency noise that may be picked up by the silver traces on the touch panel. To deal with this issue, current bending wave sensitive touch panels may have copper tape applied to the outside border to help shield the traces from external noise sources.

By using the sensor board design concepts discussed herein, a wiring harness could include a shielded wire or a shielded (multi-layer) flex circuit. An alternative method would be to use twisted pair wiring instead of shielding. This would minimize interference from both internal and external noise sources. The circuit board could also have a ground plane as a second layer to minimize interference on the circuit (or alternatively, use a conductive epoxy that is connected to ground). With these shielding improvements, it is likely that the signal-to-noise ratio seen by the controller will be increased, resulting in better performance and easier adaptation to larger size panels.

Another advantage of the shielding, in certain embodiments, is enhanced electrostatic discharge (ESD) protection. It is expected that a design incorporating several of the shielding techniques discussed above would be able to meet ESD requirements exceeding 27 kV.

### Frequency Response Using Circuit Boards of Different Thicknesses

To test the response of different configurations of corner boards, 12 corner board prototypes were built (that is, 3 sets of 4 corner boards each): 4 using 45 mil thick board, 4 using 30 mil thick board, and 4 using 15 mil thick board. Each of respective sets was then adhered to a 32″ (diagonal) glass substrate using 3M LC-1112 adhesive, then coupled to a controller using 34 AWG magnet wire that was soldered to pads on the sensor board. The wires were not shielded from external noise sources, though such shielding may in some embodiments be desirable. The panels were then tested using a voice coil placed at the center of the glass substrate. A multisine wave between 1 and 40 kHz was used to drive the voice coil and the response at each of the four corners was measured. For these tests, the glass substrate was not integrated into a display but rather resting on an acrylic sheet.

The frequency response of each of the corner boards was measured. FIG. 6 shows the averaged frequency responses for the three circuit board thicknesses. The results show little difference in the frequency response for the different circuit board thicknesses. The differences are within what would be expected from normal variation.

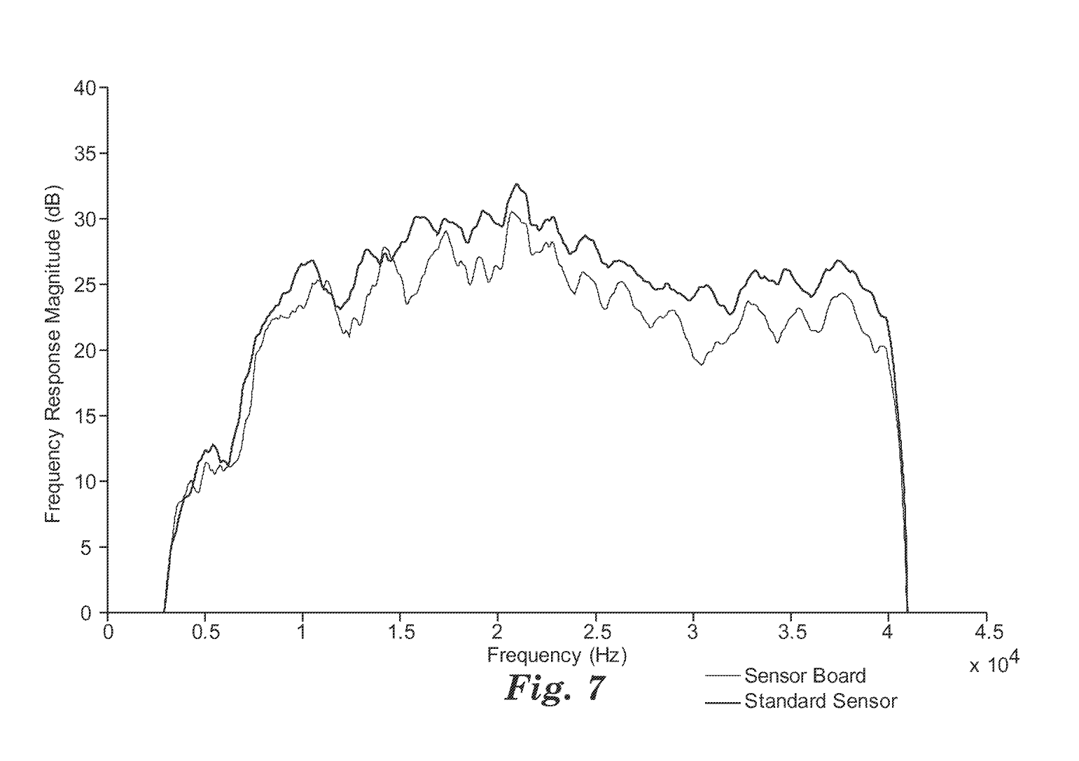

Next, the results of the 3 sets from above were compared to three standard 32″ commercially available bending wave-type touch panels to see how closely the corner boards match the magnitude of the signal levels for a standard panel. These commercially available touch panels have their piezoelectric sensor bonded directly to the substrate. The results in FIG. 7 show a general 2 to 3 dB drop in signal level for the corner boards. This is consistent with previous tests and due to signal attenuation through the various interfaces described above. However, it is expected that the decrease in noise due to the shielding described in section 3 would offset this signal loss.

### Detailed Example

A bending wave touch sensitive device using sensor boards was constructed and tested as described below.

1) The bending wave sensor substrate consisted of a rectangular plate of soda-lime float glass measuring 752 mm×433 mm (27.63″×17.07″) and 2.2±0.1 mm (0.087″±0.004″) thick, obtained from Eurptec Gmbh of Goslar, Germany. The glass had an anti-glare acid etch applied to the front surface. The glass had been chemically strengthened to a tensile strength ≧180 N/mm². The optical transmittance was >91%. The edges of the glass had been ground and rounded to have a radius≧half of the glass thickness.
2) Sensor boards were constructed and attached to each of the four corners of the non-etched surface (opposite the touch surface) of the glass plate. The sensor board substrates were pieces of typical commercial FR-4 circuit board material measuring 15.9 mm×15.9 mm (0.625″×0.625″) and 0.76 mm (0.030″) thick. (Substrates 0.015″ and 0.045″ thick have also been successfully tested.) The circuit boards were then patterned with appropriate metallic circuit traces and solder pads, as will be described below.
3) The sensor for measuring bending wave vibration on each sensor board was a piezoelectric sensor, custom model 3M Company Part #25054, obtained from Belltec of Taipei, Taiwan, similar to those disclosed in patent application US 2005/0134574, PIEZOELECTRIC TRANSDUCER. The transducers had a resonant frequency of 570 kHz±200 kHz. The transducers were 4.5±0.1 mm (0.177±0.004 inches) wide, 10.4±0.1 mm (0.409±0.004 inches) long and 1.1±0.1 mm (0.043±0.004 inches) thick. A mark on the top of the transducer indicated the positive poling direction.
4) Each sensor was provided with an amplifier circuit on its sensor board, to convert the high impedance of the piezo to a signal more compatible with the data processor, in order to minimize electrical noise. The circuit consisted of a field emission transistor (FET) buffer/amplifier, model NJFET SST204, obtained from Calogic of Fremont, Calif., USA, and two bias resistors, of 10 MOhm and 365 Ohms. The NJFET biases the voltages to about 2.2V (from the 5V input rail).
5) The piezoelectric sensors were attached to the sensor board following the procedure set forth above with reference to FIG. 5. Two metallic bond pads were formed on the circuit board, each about 40% of the area of the piezoelectric sensor itself, one for each electrode/end of the sensor. The solder used was standard Lead Free Solder, obtained from Ketster of Itasca, Ill., USA. This solder melts at 220° C. After the piezoelectric sensor had been soldered in place, the FET amplifier and bias resistors were also soldered in place on the circuit board.
6) The assembled sensor boards were next attached to the corners of the non-etched touch surface of the glass plate by means of 3M™ Light Cure Adhesive LC-1212, available from 3M Company, St. Paul, Minn., USA. This material is described as a one-component, medium viscosity adhesive that cures rapidly when exposed to visible or UV light to form a semi-rigid bond. Features include: improved glass and metal adhesion, cures to tack-free surface, and has low corrosion properties. Typical cured properties include a Shore D Hardness of 83 (ASTM 2240), a tensile strength of 3.1 MPascal (4500 pounds per square inch) (ASTM D638), and an elongation of 15% (ASTM D638). The sensor boards were placed on a portion of uncured adhesive at a corner of the glass plate, and a “Green Spot” handheld ultraviolet (UV) light source from UV Source of Lebanon, Ind., USA (100 Watt, 365 nm primary output wavelength) was directed through the glass plate to the adhesive for 40 seconds at room temperature.
7) Electrical leads consisting of unshielded type 34AWG magnet wire, available from Belden, of Richmond, Ind., USA, were then soldered to the output terminals of each of the circuit boards. These leads were then connected to a model DST-3000DC controller, of the type currently used DST bending wave touch sensors available from 3M Touch Systems, Inc., Methuen, Mass., USA.
8) The touch sensitive device then had mounting foams (3M™ VHB Acrylic Foam Tape 5925 and 3M™ VHB Acrylic Foam Tape 5962, available from 3M Company, St. Paul, Minn., USA) applied to the four edges of the touch sensor, as is standard for integrating a 3M™ DST bending wave touch sensor onto the front of a display device. The sensor was then mounted in a 32″ diagonal NEC 3210 liquid crystal display (available from NEC Corporation, Tokyo, Japan) for the remainder of the tests.
9) The performance of the assembled bending wave contact sensitive device was then compared to that of the current 3M Touch Systems DST bending wave sensor product, and was shown to meet the same specifications for accuracy and sensitivity, as described below. The contact sensitive device under test was mounted in a device capable of providing a series of taps or touch impulses with millimeter positional accuracy and with calibrated force-time impulses. The “tapper” is moved to a selected location adjacent the contact sensitive device and a series of 30 taps at a low impulse value (a few mNt-sec). The number and calculated location of detected taps is recorded. The process is repeated at the same location using taps having a higher impulse value, until the device is able to record all 30 taps. The current product is required accurately locate all 30 touches at an impulse less than 50 mNt-sec. The assembled bending wave contact sensitive device of this example also met these requirements.

Manufacturing touch sensitive bending-wave type panels using corner boards as described here could significantly reduce the cost of equipment needed to produce traditional bending wave-type touch sensors, which often require screen printers (for printing conductive traces) and ovens (for curing the conductive traces). Such printers and ovens may not be required given certain embodiments disclosed herein.

Further, in some embodiments, a kit containing sensor boards, wiring, and the controller board (or some combination of these things, or additional things such as adhesive for securing the sensor board to the substrate) could be purchased by a customer interested in manufacturing a touch sensitive substrate. For example, an LCD manufacturer could source its own glass substrate then assemble a touch sensitive panel using the above mentioned kit. This may afford the LCD manufacturer a great deal of manufacturing flexibility and cost savings.

A number of embodiments have been described above. The invention, however, may be embodied in many different forms and should not be construed as limited to the embodiments set forth herein; rather, these embodiments are provided so that this disclosure will be thorough and complete, and will fully convey the scope of the invention to those skilled in the art.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims.

What I claim is:

1) A contact sensitive device comprising:
a first substrate capable of propagating bending wave vibration and having a touch surface;
at least one sensor board coupled to the substrate, the sensor board including a second substrate onto which is mounted a sensor for measuring bending wave vibration of the first substrate; and
a processor communicatively coupled to the at least one sensor board for processing information from the sensor related to a contact made on the touch surface.

2) The contact sensitive device of claim 1, wherein processing information comprises resolving the X and Y coordinates of the contact made to the touch surface.

3) The contact sensitive device of claim 2, wherein the sensor board is coupled to the substrate using an adhesive.

4) The contact sensitive device of claim 2, wherein the first substrate is a sheet of glass.

5) The contact sensitive device of claim 4, wherein the sheet of glass is of uniform thickness.

6) The contact sensitive device of claim 2, wherein the substrate is transparent or semi-transparent and has four corners, and wherein the at least one sensor board comprises four sensor boards, which are coupled proximate the four corners of the substrate.

7) The contact sensitive device of claim 6, further comprising:
a display device positioned proximate the first substrate to provide visual stimuli through the first substrate.

8) The contact sensitive device of claim 7, further comprising:
a computer communicatively coupled to the display device to control visual stimuli on the display, and wherein the processor is further communicatively coupled to the computer and provides information indicative of coordinates of contacts made to the display device.

9) An apparatus comprising:
a circuit board having at least two conductive pads on a first circuit board surface, the two conductive pads each having a surface area;
a sensor capable of sensing bending waves, the sensor having at least two conductive connection points on a first sensor surface, the first sensor surface having a surface area;
wherein at least a portion of each of the at least two sensor pads are mechanically and electrically coupled to at least two areas of the first sensor surface that include the two conductive connection points;
and wherein the surface area of the first sensor surface that is mechanically coupled to the two pads is greater than 20% of the total first sensor surface area.

10) The apparatus of claim 9, wherein the sensor is a piezoelectric sensor.

11) The apparatus of claim 10 wherein the sensor pads are coupled to the first sensor surface using solder.

12) The apparatus of claim 10, wherein the total surface area of the at least two pads is at least 50% of the surface are of the first sensor surface.

13) A method of making a touch sensitive device comprising:
mechanically coupling at least three sensor boards to a substrate, the sensor boards each including at least a piezoelectric sensor capable of measuring bending waves and providing signals indicative of measured bending waves;
communicatively coupling the at least three sensor boards to electronics, the electronics configured to receive signals from the piezoelectric sensor and based on these signals provide signals indicative of the coordinates of a contact made to the substrate.

14) The method of claim 13, wherein the at least three sensor boards is four sensor boards.

15) The method of claim 14, wherein mechanical coupling comprises using adhesive.

16) The method of claim 15, wherein communicatively coupling comprises electrically coupling using conductors.

17) The method of claim 16, wherein the substrate is glass.

18) The method of claim 17, further comprising:
mechanically coupling the substrate to a display device such that the display may be viewed through the substrate.
